(19) United States
(12) Patent Application Publication
(10) Pub. No.: US 2007/0130349 A1
(43) Pub. Date: Jun. 7, 2007

(54) Systems and methods for reputational analysis of network content

(76) Inventor: Meng Weng Wong, Campbell, CA (US)

Correspondence Address: PERKINS COIE LLP, P.O. BOX 2168, MENLO PARK, CA, 94026, US

(21) Appl. No.: 11/594,559

(22) Filed: Nov. 7, 2006

Related U.S. Application Data
(60) Provisional application No. 60/734,588, filed on Nov. 7, 2005.

(51) Int. Cl. G06F 15/16

(52) U.S. Cl. 709/229

(57) ABSTRACT

Systems and methods are described to evaluate the reputation of Internet communications. The system and methods of the present invention can be applied to a variety of communications systems, which include, by way of example but not limitation, the following: email antispam blogging comment spam and splogs Instant Messaging Voice over IP “safe” web browsing product reviews personal credit checks business credit ratings marketplace reputation systems dating services ancillary industries that grow up around regular POTS Caller-ID services (e.g. automatic call screeners)

### CLAIM OF PRIORITY

This application claims priority to U.S. Provisional Patent Application No. 60/734,588, filed Nov. 7, 2005, which is hereby incorporated by reference in its entirety

### FIELD OF THE INVENTION

This invention relates to the field of computer networking, and more particularly to the field of network security.

### BACKGROUND OF THE INVENTION

Every medium for communication can be abused for the telling of lies. Criminals exploit this weakness by constructing fictions that operate at the expense of gullible innocents. Those innocents can respond in two ways: they can lose their innocence and become hardened skeptics, or they can reduce their exposure by retreating from the lawless frontier to a trusted sphere. There is a need for an accountability framework of authentication and reputation, along with varying degrees of identification, to allow for trustworthy Internet communication.

### SUMMARY OF THE INVENTION

The invention includes systems and methods to evaluate the reputation of Internet communications to the accountability framework. The system and methods of the present invention can be applied to a variety of communications systems, which include, by way of example but not limitation, the following:
email antispam
blogging comment spam and splogs
Instant Messaging
Voice over IP
“safe” web browsing
product reviews
personal credit checks
business credit ratings
marketplace reputation systems
dating services
ancillary industries that grow up around regular POTS Caller-ID services (e.g. automatic call screeners)

### BRIEF DESCRIPTION OF THE DRAWINGS

FIG. 1 illustrates a system for distributing reputational data, in accordance with embodiments of the invention.

### DETAILED DESCRIPTION OF THE INVENTION

Every medium for communication can be abused for the telling of lies. Criminals exploit this weakness by constructing fictions that operate at the expense of gullible innocents. Those innocents can respond in two ways: they can lose their innocence and become hardened skeptics, or they can reduce their exposure by retreating from the lawless frontier to a trusted sphere. The present invention is intended to facilitate the establishment of that trusted sphere for internet communications. The invention includes an accountability framework of authentication and reputation, along with varying degrees of identification, to form the basis for future interaction on the Internet.

Embodiments of the invention include a reputation component to the accountability framework. Embodiments of the invention may be applied in the context of messaging systems which are already under attack—namely, email and blogs. Other systems to which the present systems and methods may be applied include, by way of example but not limitation, the following:
email antispam
blogging comment spam and splogs
Instant Messaging (e.g. AIM, Yahoo Messenger, Jabber)
Voice over IP (e.g. Skype, Google Talk)
“safe” web browsing (e.g. Earthlink Scamblocker Toolbar)
product reviews (e.g. Epinions.com)
personal credit checks (e.g. Experian, Equifax)
business credit ratings (e.g. Dun & Bradstreet)
marketplace reputation systems (e.g. eBay Reputation)
dating services (e.g. http://www.dontdatehimgirl.com/)
ancillary industries that grow up around regular POTS Caller-ID services (e.g. automatic call screeners)

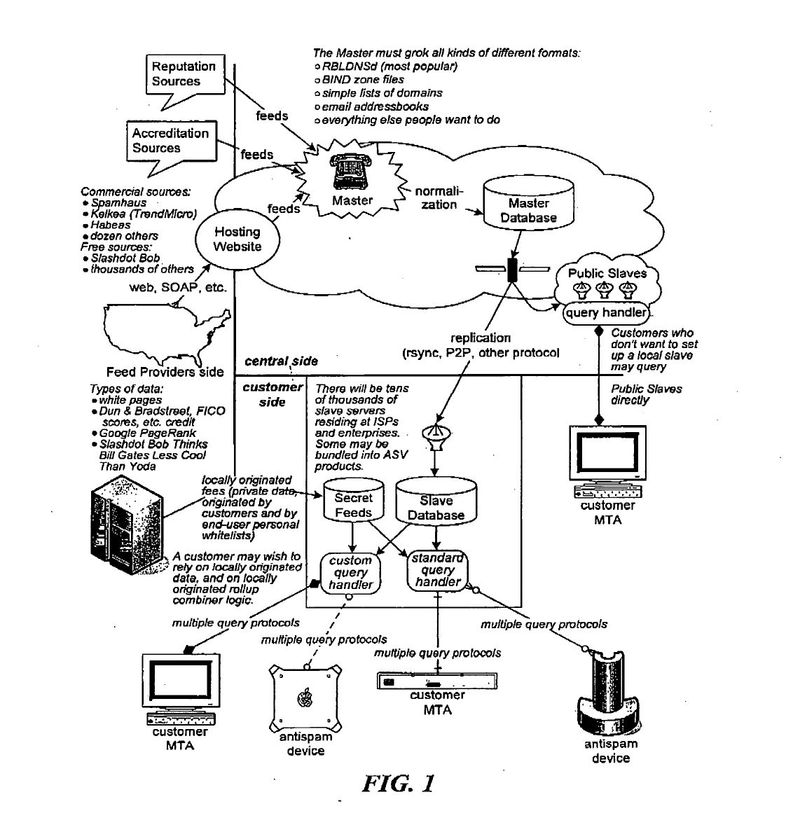

Separate Premises. FIG. 1 illustrates the following entities: Feed Providers, on the left, act as suppliers of data to us; a centralized site, at top, processes that data; and on the customer side, at bottom, slaves draw on that data to answer queries from clients.

Direction of Data Flow. In embodiments of the invention illustrated in FIG. 1, reputation data flows from opinion sources (top left) into the master database. It spreads from the master database into a collection of slave databases. (Both master and slave databases are operated by software; references to the master server and the slave server refer to the software and the database operating together.) The slave databases answer queries that come from clients located at the customer premises.

Slaves usually reside at the Customer Premises. In embodiments of the invention, customers run a software package that contains the slave server. In embodiments of the invention, that slave server sits inside their network and answers queries from their clients. While physically resident at customer premises, a Slave remains connected with the Central site and regularly receives updated feeds. Because clients and servers are network-local to each other, query latency is reduced, and the need for security is lessened.

Slaves sometimes reside at the Central site. Some customers may choose not to install a local slave server. In some such embodiments, public slaves may be made available for their use. In embodiments, such slaves will implement access control so that they will know who is doing a query, and, can, if applicable, convey a message to the following effect: “sorry, that information is on a paid-to-know basis only, and you haven't paid to know.” These are depicted at the right side of FIG. 1.

Email Clients. In embodiments, clients may be located inside mail transfer agents (MTAs) and antispam software. They include, by way of example but not limitation:
free and opensource packages (e.g. SpamAssassin)
commercial appliances (e.g. Barracuda)
MX defenses (e.g. MessageLabs)
back-side filters (e.g. Brightmail)
front-side edge filters (e.g. Openwave Edge GX).
plugins to MTAs (e.g. Sendmail Milters, Exchange plugins)

Non-email clients. For other contexts and for other messaging media, clients may include, by way of example but not limitation, the following:
blog software (e.g. LiveJournal servers)
VoIP software (e.g. softswitch servers and VoIP clients)
Instant Messaging software (e.g. Jabber servers, IM clients such as Trillian, GAIM, iChat)

Client-server query protocol. Clients query the slave server. They ask the slave about a given identity vector made up of one or more identifiers. (An example list of identifiers is given below.) They pass additional parameters in the query, such as, by way of example but not limitation: which feeds to query; the context in which the identifiers were seen; how multiple scores should be combined into a single verdict. Because different clients may prefer different protocols, slaves support multiple protocols, including DNS, SOAP, HTTP, and a custom binary encoding (bencoding) format. Other protocols and data formats may be supported as well, such as YAML and BEEP. Yet other examples shall be readily apparent to those skilled in the art.

Replication from Master to Slave. Data moves from the Master to the Customer Slave down the line labeled “replication: rsync, P2P, other protocol”. There are a number of ways this replication will be implemented. In one, non-limiting embodiment, the slave connects to a Central master and receives updates on an ongoing basis. In a Peer-to-Peer embodiment, the slave connects to other slaves and performs replication in a fashion similar to BitTorrent or Distributed Hash Tables. In embodiments of the invention, the Central site will operate a number of seed slaves which act to seed the P2P network.

External Data Sources: DNSBLs. There are a number of reputation sources today. The best known are Domain Name Service Black Lists, or DNSBLs. One of the best known and best respected is Spamhaus; other respected DNSBLs include Spamcop, DSBL, SURBL, and blackholes.us; other examples shall be readily apparent to those skilled in the art. There are perhaps two hundred other DNSBLs which are less well known; these are operated by hobbyists and small installations. Most DNSBLs describe IP addresses. Some DNSBLs describe domain names. Most DNSBLs are noncommercial. Some DNSBLs try to collect money.

External Data Sources: DNSWLS. Instead of saying that a subject is bad, DNS Whitelists say that a subject is good. These can also describe IP addresses and domain names.

External Data Sources: Accreditation Services. There is a small industry of accreditation services: Bonded Sender, Habeas, and (in a certain light) VeriSign; other examples shall be readily apparent to those skilled in the art Upon successful vetting, they publicly vouch for their customers and say “you should accept mail from this sender.” These sources operate similarly to DNSWLs.

Data Source File Formats and Accessibility. Many data sources offer their databases in a standard file format named for RBLDNSd, a popular DNS server package designed to answer DNSBL requests. They make their RBLDNSd files available via HTTP or RSYNC. Some data sources use BIND zone file formats instead. These are provided as examples only, and the invention may support any other formats which become popular among data providers. By way of example, if data providers start uploading address books, Excel spreadsheets, and so on, the present invention will accommodate such data sources.

Hosted feeds. Some data sources may choose not to publish their data using their own facilities; instead, they may choose to host their data with the central site, in the same way that many web content providers choose to use Geocities instead of Apache.

Some feeds are public, some private, some secret. All such data sources may be included in the reputation analysis undertaken in accordance with the present invention.

Certain data providers may say “we only want certain clients to be able to query this data.” Embodiments of the invention support competitive exclusion as follows: ISP X might say “we want everybody except ISP Y to read our safelist”; ISP Z might say “we want everybody except Portal XX to use our whitelist.” Such feeds would be marked private rather than public. Access controls could be defined as “deny unless . . . ” or as “allow unless . . . ”.

And some data providers might say “we want nobody but ourselves to be able to read this.” Such feeds would be considered secret. For instance, a customer might say, “here is a big list of domains that we blacklist, but we don't want anybody else to find out about this list. But we do want to use the slave to handle queries. Can that slave answer in addition to the standard feeds that we've subscribed to? Can it also answer based on our secret internal blacklist?” In embodiments of the invention, secret feeds may remain at the customer premises; that data would never leave their network, and would never make it to the central site. It would be fed directly from the local customer-side reputation source into the slave server, and the slave server would use it as an input just as it uses the sourced feeds as an input.

Secret Feeds Implemented as Private Feeds. Some sites may want secret-feed functionality, but they may not have the wherewithal to configure a secret feed at the slave server; or they may not have a slave server installed locally. In such cases, they would upload their secret feeds to the Master, and mark them private; and they would be the only people allowed to read that feed.

Some feeds are commercial and some feeds are free. While most DNSBL sources today offer their data with no expectation of return, some DNSBL sources operate on a commercial (profit-seeking) or semi-commercial (cost-recovery) basis. In embodiments of the invention, such feeds will be marked “commercial”, and only customers who have paid for those feeds will be given access to them.

Hashing to preserve the plaintext. Suppose a customer wants to give out data that can be queried, but not read. As a solution, embodiments of the invention hash the plaintext of the feed, so that it's possible to ask “is this IP address on the list” and get back a response; but it's not possible to simply scan the list and read off the IP addresses that are in it.

One-time Piracy defeated by Time. Hollywood's DRM efforts are focused on protecting a big blob of static data: the four gigabytes of media that make up a motion picture are a precious commodity, and once they've been decrypted and copied, the game is over. However, the data provided hereunder is time-sensitive: only fresh data is worth anything.

Piracy defeated by steganography and revocation. Suppose there is a leak in the system. For instance, suppose that a customer is unwrapping the data and reselling it. Embodiments of the invention locate the leak and stop them from reading the data. In one such embodiment, all data is encrypted using a key that is exchange regularly; and if it the users/system administrators decide to kick somebody out of the system, they are not given the new key.

Identifiers. The present system will handle, by way of example but not limitation, the following identity types: IP addresses, Internet domain names, email addresses, Instant Messaging handles and nicknames, handles and nicknames and pseudonymous identifiers used in virtual reality systems, Universal Resource Identifiers, Universal Resource Names, Universal Resource Locators and parts thereof, website URLs, RSS feed URLs, proper names, telephone numbers, social security numbers, driver's license numbers, state-issued identification document numbers, passport numbers, citizenship identification numbers, vehicle license plates, street addresses, geographical coordinates, Universal Unique Identifiers (UUIDs), any other identifier that may be used to identify a natural person, corporation, concept, place, or thing; or any combination of the above; or an arbitrary string of bytes or data object; or the hashed form of any of the above.

Query Variants. In the standard form, a Slave asks about a given identity vector. Embodiments of the invention answer more elaborate queries. For example, the system may answer a query such as: “given two identity vectors, what is the web of trust between the two? Display all the paths of length six or lesser.”

Conclusion. Examples provided herein are for illustrative purposes only. Many alternatives shall be readily apparent to those skilled in the art.

What is claimed is:

1. A system of collecting and distributing reputational data for internet communications, comprising:
collecting one or more feeds containing reputational data regarding a plurality of entities communicating via the Internet;
determining a reputation metric for each of the plurality of entities;
distributing the reputation metric for one or more of the plurality of entities from one or more master servers to one or more slave servers;
receiving the reputation metric for the one or more of the plurality of entities at the one or more slave servers;
determining whether or not to allow Internet content for one or more of the plurality of entities based on the reputation metric received at the one or more slave servers.
